(19) United States
(12) Patent Application Publication
(10) Pub. No.: US 2026/0097719 A1
(43) Pub. Date: Apr. 9, 2026

(54) VEHICLE HAVING SCUFF PLATE WITH STEP FOR REAR ROW SEAT ACCESS

(71) Applicant: Ford Global Technologies, LLC, Dearborn, MI (US)

(72) Inventors: Luis Manuel Aviles Fuentes, Mexico City (MX); Andrés Del Olmo Gil, Mexico City (MX); Sandra Cristina Alvarado Gomez, Ciudad López Mateos (MX); Humberto Memetla Martinez, Mexico City (MX)

(73) Assignee: Ford Global Technologies, LLC, Dearborn, MI (US)

(21) Appl. No.: 18/910,070

(22) Filed: Oct. 9, 2024

(51) Int. Cl. B60R 13/02; B60N 2/01; B60R 3/00

(52) U.S. Cl. CPC B60R 13/0206; B60N 2/01; B60R 3/00; B60R 2013/0287

(57) ABSTRACT

A vehicle has a first row of seating, a second row of seating rearward of the first row of seating and a side access door located in a door opening positioned proximate to the first row of seating. the first row of seating has a first row seat that is moveable vehicle-forward to allow access to the second row of seating via the door opening. A scuff plate is located proximate a lower edge of the door opening. The scuff plate has a front portion extending generally along a lower surface of the door opening and a rear portion extending rearward and inward proximate to a rear end of the first row seat. A step pad provides a footpad top surface configured to support a foot of an occupant to access the second row of seating.

### FIELD OF THE DISCLOSURE

The present disclosure generally relates to motor vehicles equipped with side door access to a rear row of passenger seating, and more particularly relates to a step assembly for accessing the rear row of seating in a motor vehicle.

### BACKGROUND OF THE DISCLOSURE

Motor vehicles are commonly equipped with multiple rows of seating in the passenger compartment which are typically accessed via one or more side access doors. Some motor vehicles are equipped with a rear row of seating that is accessed by tilting and/or sliding a forward row of seating forward to gain access to the rear row of seating. It would be desirable to provide for a step assembly for enhanced access to the rear row of seating.

### SUMMARY OF THE DISCLOSURE

According to a first aspect of the present disclosure, a vehicle has a first row of seating, a second row of seating rearward of the first row of seating and a side access door located in a door opening positioned proximate to the first row of seating. the first row of seating has a first row seat that is moveable vehicle-forward to allow access to the second row of seating via the door opening. A scuff plate is located proximate a lower edge of the door opening. The scuff plate has a front portion extending generally along a lower surface of the door opening and a rear portion extending rearward and inward proximate to a rear end of the first row seat. A step pad provides a footpad top surface configured to support a foot of an occupant to access the second row of seating.

Embodiments of the first aspect of the present disclosure can include any one or a combination of the following features:
the first row seat has a seat track, wherein the rear portion of the scuff plate extends inward to at least partially abut the seat track;
the rear portion of the scuff plate extends at least partially over the seat track;
the rear portion of the scuff plate at least partially covers a seatbelt anchor;
a plurality of connector clips for attaching the scuff plate to underlying structure supported on a floor of the vehicle;
the footpad top surface has an anti-slip pattern;
the first row seat has a seat base and a seat back, wherein the seat and seat back are configured to move longitudinally forward to provide access to the second row seating;
the seat back further tilts forward to provide access to the second row of seating;
a third row of seating that serves as a front row of seating, and wherein the first row of seating serves as a middle row of seating and wherein the second row of seating serves as a rear row of seating;
the scuff plate comprises a polymeric material; and
the footpad is integrally formed in the scuff plate.

According to a second aspect of the present disclosure, a vehicle has a front row of seating, a middle row of seating rearward of the front row of seating and a rear row of seating rearward of the middle row of seating. A side access door located in a door opening is positioned proximate to the middle row of seating. The middle row of seating has a middle row seat that is moveable vehicle-forward to allow access to the rear row of seating via the door opening. A scuff plate is located proximate a lower edge of the door opening. The scuff plate comprises a front portion extending generally along an upper surface of the door opening and a rear portion extending rearward and inward proximate to a rear end of the middle row of seating. A step pad provides a footpad top surface configured to support a foot of an occupant to access the rear row of seating.

Embodiments of the second aspect of the present disclosure can include any one or a combination of the following features:
the middle row seat has a seat track, wherein the rear portion of the scuff plate extends inward to at least partially abut the seat track;
the rear portion of the scuff plate extends at least partially over the seat track;
the second portion of the scuff plate at least partially covers a seatbelt anchor;
a plurality connector clips for attaching the scuff plate to underlying structure supported on a floor of the vehicle;
the footpad top surface has an anti-slip pattern;
the middle row seat has a seat base and a seat back, wherein the seat base and seat back are configured to move longitudinally forward to provide access to the rear row seating;
the seat back further tilts forward to provide access to the rear row of seating; and
the scuff plate comprises a polymeric material and the step pad is integrally formed in the scuff plate.

These and other features, advantages, and objects of the present disclosure will be further understood and appreciated by those skilled in the art by reference to the following specification, claims, and appended drawings.

### BRIEF DESCRIPTION OF THE DRAWINGS

In the drawings:

FIG. 1 is a top view of a motor vehicle having a rear row of seating and side access doors with scuff plates having a step pad, according to one example;

FIG. 2 is another side perspective view of a side door opening relative to the vehicle seating and the scuff plate proximate thereto;

FIG. 2A is an outer side exploded view of the scuff plate exploded from the door sill and floor as seen in FIG. 2;

FIG. 3 is another side perspective view of the scuff plate having the step pad formed therein;

FIG. 4 is an interior side perspective view of the scuff plate installed on the vehicle door sill and floor;

FIG. 4A is an interior side exploded view of the scuff plate shown in FIG. 4;

FIG. 5 is an inner side perspective view of the scuff plate;

FIG. 6 is a lower perspective view of the scuff plate connected to underlying structure in the vehicle;

FIG. 6A is an exploded lower perspective view of the scuff plate and assembly connections on the vehicle;

FIG. 7 is an enlarged lower perspective view of section VII of FIG. 6 illustrating the connection of a tab in a slot; and

FIG. 7A is an exploded lower perspective view of the connection of the tab and slot shown in FIG. 7.

### DETAILED DESCRIPTION OF PREFERRED EMBODIMENTS

Reference will now be made in detail to the present preferred embodiments of the disclosure, examples of which are illustrated in the accompanying drawings. Wherever possible, the same reference numerals will be used throughout the drawings to refer to the same or like parts. In the drawings, the depicted structural elements are not to scale and certain components are enlarged relative to the other components for purposes of emphasis and understanding.

As required, detailed embodiments of the present disclosure are disclosed herein; however, it is to be understood that the disclosed embodiments are merely exemplary of the disclosure that may be embodied in various and alternative forms. The figures are not necessarily to a detailed design; some schematics may be exaggerated or minimized to show function overview. Therefore, specific structural and functional details disclosed herein are not to be interpreted as limiting, but merely as a representative basis for teaching one skilled in the art to variously employ the present disclosure.

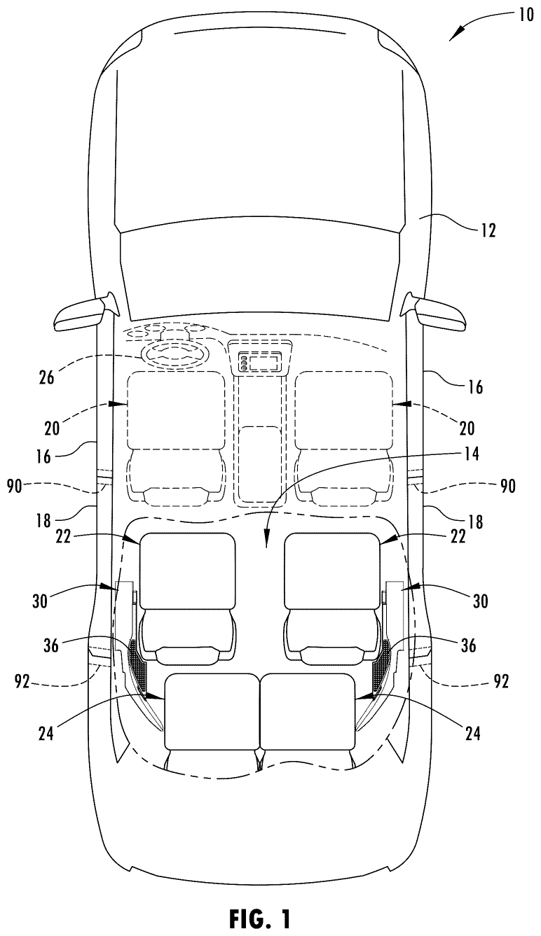

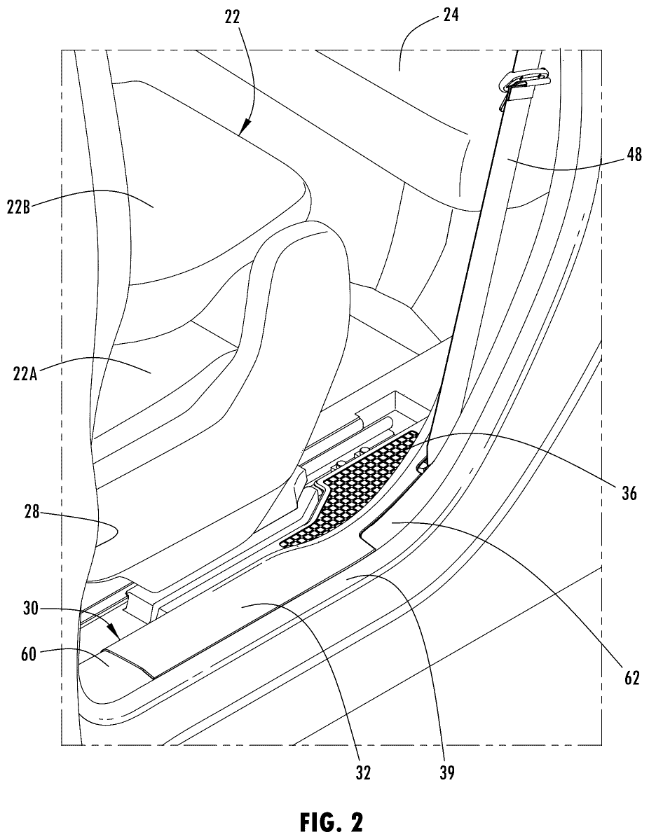

For purposes of description herein, the terms “upper,” “lower,” “right,” “left,” “rear,” “front,” “vertical,” “horizontal,” and derivatives thereof shall relate to the concepts as oriented in FIG. 1. However, it is to be understood that the concepts may assume various alternative orientations, except where expressly specified to the contrary. It is also to be understood that the specific devices and processes illustrated in the attached drawings, and described in the following specification are simply exemplary embodiments of the inventive concepts defined in the appended claims. Hence, specific dimensions and other physical characteristics relating to the embodiments disclosed herein are not to be considered as limiting, unless the claims expressly state otherwise.

The present illustrated embodiments reside primarily in combinations of method steps and apparatus components related to a vehicle having a scuff plate with a footpad. Accordingly, the apparatus components and method steps have been represented, where appropriate, by conventional symbols in the drawings, showing only those specific details that are pertinent to understanding the embodiments of the present disclosure so as not to obscure the disclosure with details that will be readily apparent to those of ordinary skill in the art having the benefit of the description herein. Further, like numerals in the description and drawings represent like elements.

As used herein, the term “and/or,” when used in a list of two or more items, means that any one of the listed items can be employed by itself, or any combination of two or more of the listed items, can be employed. For example, if a composition is described as containing components A, B, and/or C, the composition can contain A alone; B alone; C alone; A and B in combination; A and C in combination; B and C in combination; or A, B, and C in combination.

In this document, relational terms, such as first and second, top and bottom, and the like, are used solely to distinguish one entity or action from another entity or action, without necessarily requiring or implying any actual such relationship or order between such entities or actions. The terms “comprises,” “comprising,” or any other variation thereof, are intended to cover a non-exclusive inclusion, such that a process, method, article, or apparatus that comprises a list of elements does not include only those elements but may include other elements not expressly listed or inherent to such process, method, article, or apparatus. An element preceded by “comprises . . . a” does not, without more constraints, preclude the existence of additional identical elements in the process, method, article, or apparatus that comprises the element.

As used herein, the term “about” means that amounts, sizes, formulations, parameters, and other quantities and characteristics are not and need not be exact, but may be approximate and/or larger or smaller, as desired, reflecting tolerances, conversion factors, rounding off, measurement error and the like, and other factors known to those of skill in the art. When the term “about” is used in describing a value or an end-point of a range, the disclosure should be understood to include the specific value or end-point referred to. Whether or not a numerical value or end-point of a range in the specification recites “about,” the numerical value or end-point of a range is intended to include two embodiments: one modified by “about,” and one not modified by “about.” It will be further understood that the end-points of each of the ranges are significant both in relation to the other end-point, and independently of the other end-point.

The terms “substantial,” “substantially,” and variations thereof as used herein are intended to note that a described feature is equal or approximately equal to a value or description. For example, a “substantially planar” surface is intended to denote a surface that is planar or approximately planar. Moreover, “substantially” is intended to denote that two values are equal or approximately equal. In some embodiments, “substantially” may denote values within about 10% of each other, such as within about 5% of each other, or within about 2% of each other.

As used herein the terms “the,” “a,” or “an,” mean “at least one,” and should not be limited to “only one” unless explicitly indicated to the contrary. Thus, for example, reference to “a component” includes embodiments having two or more such components unless the context clearly indicates otherwise.

Referring to FIGS. 1-6A, a motor vehicle 10 is generally illustrated having rows of seating including at least a first row of seating and a second row of seating rearward of the first row of seating. The motor vehicle 10 has a side access door located in a door opening positioned proximate to the first row of seating, wherein the first row of seating has a first row seat that is moveable vehicle-forward to allow access to the second row of seating via the door opening. The motor vehicle 10 further includes a scuff plate 30 located proximate a lower edge of the door opening. The scuff plate 30 includes a first portion extending generally along an upper surface of the door opening and a second portion extending rearward and inward proximate to a rear end of the first row seat and having a step pad surface provided thereon for providing a footpad top surface configured to support a foot of an occupant to access the second row of seating.

With particular reference to FIG. 1, the motor vehicle 10 is generally illustrated configured with passenger seating for transporting one or more passengers including a driver of the motor vehicle. The passenger seating includes multiple rows of seating. The motor vehicle 10 generally has a vehicle body 12 generally defining a cabin interior 14. The cabin interior 14 serves as a passenger compartment which includes a first front row of seats 20, a second middle row of seats 22 and a third rear row of seats 24. The first front row of seats 20 generally includes a driver's seat located vehicle rearward of a steering wheel 26. It should be appreciated that the motor vehicle 10 includes at least a first row and a second rearward row of seats arranged behind the first row of seats, but may include three rows of seating as shown or more than three rows of seating for longer extended vehicles. In the example shown, the first, second and third rows of seats 20, 22 and 24 may be configured as Captain's seats, for example, laterally spaced apart; however, it should be appreciated that the motor vehicle 10 may include bench-style or split bench-style seats. It should be further appreciated that the motor vehicle 10 may be a motor vehicle such as a wheeled car, truck, SUV, van or bus, for example.

The vehicle body 12 is shown configured with side access doors on opposite lateral left and right sides of the motor vehicle 10, including front side access doors 16 and rear side access doors 18. The motor vehicle 10 has support pillars 90 located between the front side access doors 16 and the rear side access doors 18 and also has support pillars 92 located rearward of the rear side access doors 18. The front side access doors 16 are positioned on opposite sides within door openings that enable access to the front row of seats 20. The rear side access doors 18 are positioned rearward on opposite sides within door openings to the side of the second row of seats 22 and allow access to the cabin interior 14 to access both the second row of seats 22 and the rear most third row of seats 24. To access the third row of seats 24, a passenger user may flip a seat back 22B of a second row seat 22 vehicle forward and/or may slide the seat base 22A of seat 22 forward to make space available behind the second row of seats 22 to enter the door opening to enter the cabin interior 14 rearward of the stowed seat 22 and gain access to the third row of seats 24.

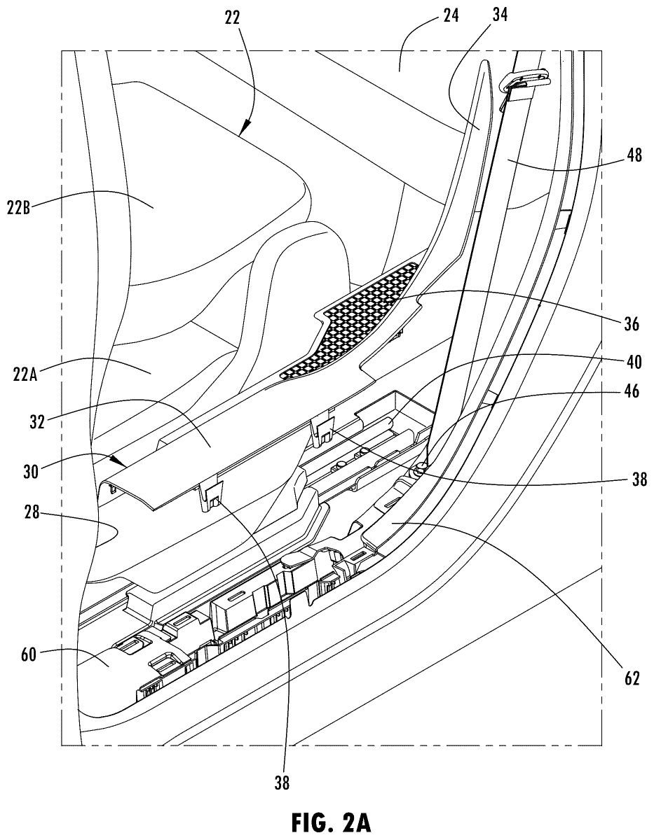

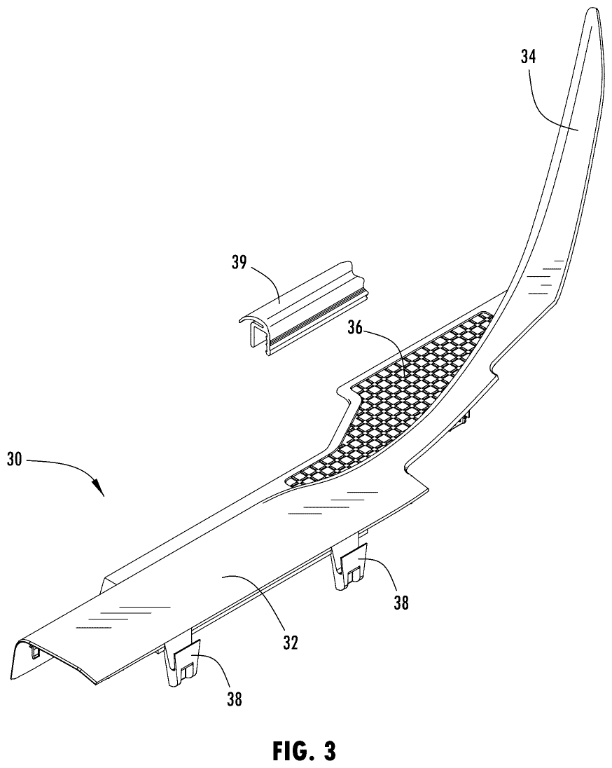

The rear side door opening 28 is further illustrated in FIGS. 2 and 2A with the rear side access door 18 removed. The rear side door opening 28 defines an access opening for entering and exiting the cabin interior 14. A second row seat of the second row of seats 22 is shown adjacent to the door opening 28 in a stowed position with the seat back 22B folded down and the seat base 22A translated forward on a seat track 40 to provide a space for entering or exiting the motor vehicle 10 rearward of the second row of seats 22 to enable an occupant to enter or exit the third row of seats 24 via the door opening 28. Located within the lower portion of the door opening 28 is the scuff plate 30 which generally extends along a lower surface of the door opening 28 and further extends vehicle rearward and inwards towards the interior of the cabin interior 14. The scuff plate 30 is illustrated in FIG. 3 having a front portion 32 which extends along the lower portion of the rear side door opening 28 and a rear portion 34 which extends vehicle rearward and extends around a support pillar trim panel 62 which covers a support pillar. The scuff plate 30 includes a step pad 36 on the rear portion 34 which extends vehicle inward. The step pad 36 is integrally formed with the scuff plate 30 and includes a footpad top surface with an anti-slid pattern with enhanced friction structural surface which serves as a location for an occupant to place their foot upon entering or exiting the cabin interior 14 through the access door opening 28 to enter or exit the third row of seating 24. The step pad 36 is configured to support the foot of an occupant accessing the third row of seating 24.

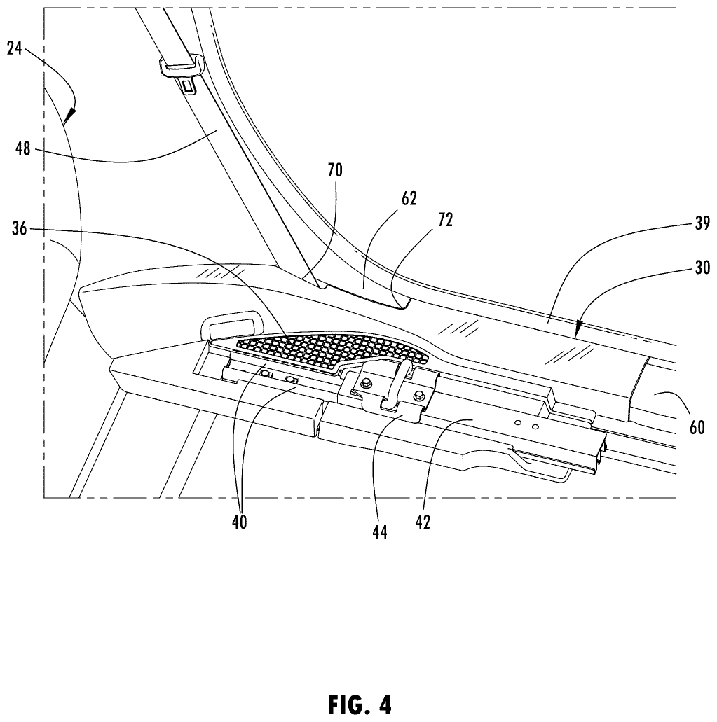

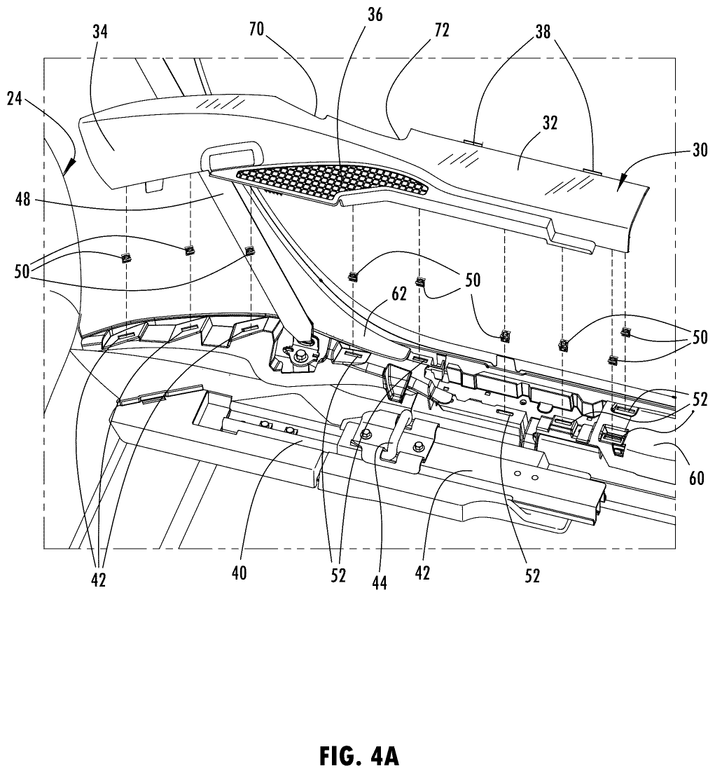

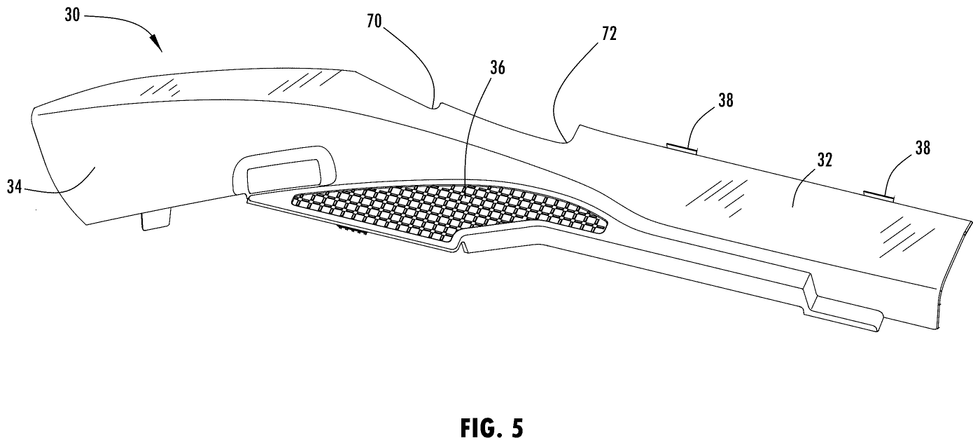

The scuff plate 30 is shown in FIGS. 4-5 extending generally over an underlying structure supported by the floor and extending over a portion of a forward support pillar trim panel 60 and the rear support trim panel 62 which engages along shaped edge 72. The scuff plate 30 covers a seatbelt anchor 46 that includes a mounting plate and bolt that mounts the seatbelt 48 onto the vehicle floor. The scuff plate 30 extends vehicle inward within the cabin interior 14 and abuts the second row of the seat track assembly which includes the seat track 40 which is fixed to the vehicle floor and has a seat rail 42 which may slide with the seat on the seat track 40 to translate vehicle forward and rearward. The scuff plate 30 provides a platform surface extending vehicle inward to the seat track 40 in an ideal location for placement of a foot of an occupant entering and exiting the motor vehicle 10.

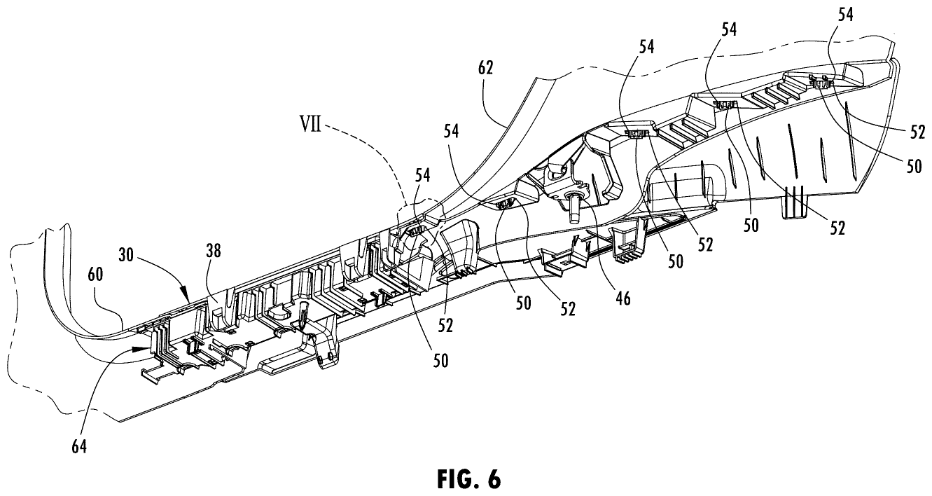

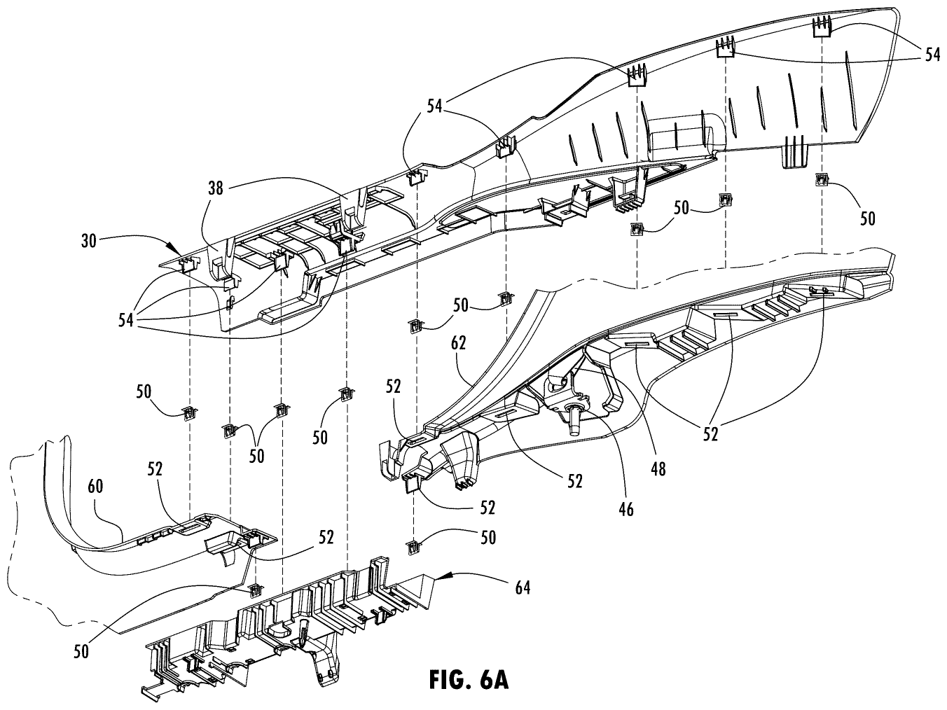

The scuff plate 30 as seen in FIGS. 6 and 6A is assembled onto the underlying structure and also connects to the support pillar trim panels 60 and 62 and an underlying wiring shield 64. The scuff plate 30 includes a plurality of tabs 54 which matingly engage a corresponding plurality of clips 50 that extend from the scuff plate 30 into the underlying structures which are equipped with slots 52. As such, the clips 50 lockingly engage the scuff plate 30 onto the underlying structure within slots 52 to hold the scuff plate 30 in place.

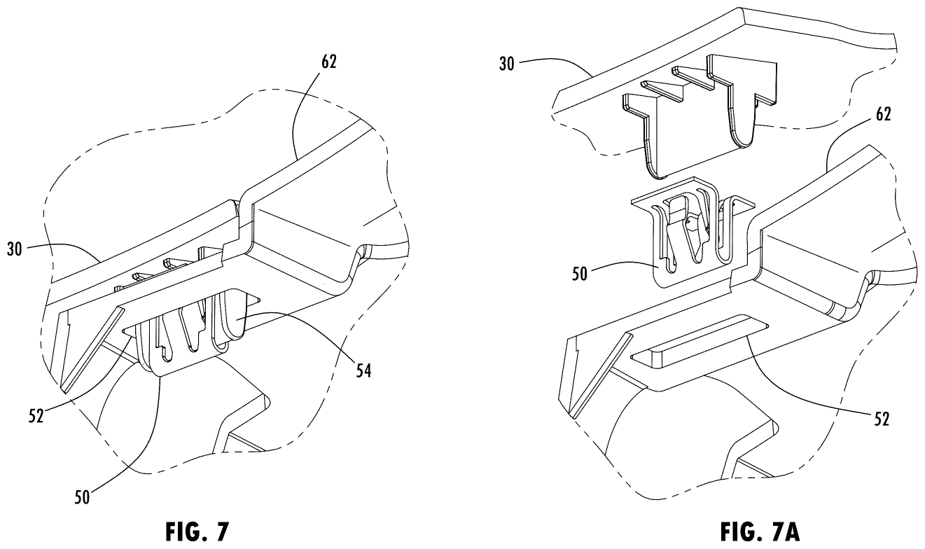

The locking connection of the tabs 54 extending into matingly engagement in corresponding slots 52 of an underlying structure shown as the rear support pillar trim panel 62 is illustrated in FIGS. 7 and 7A. The scuff plate 30 has each tab 54 configured to engage with the clip 50 which extends downward and makes an interlocking connection with slot 52 to hold the scuff plate 30 connected to the underlying structure. The clip 50 has interlocking arms which bend inward and once extended through slot 52 are biased outward with a shaped surface to lock the clip 50 in place within the slot 52. It should be appreciated that other types of connectors may be employed to connect the scuff plate 30 to the underlying structure.

The scuff plate 30 may be made of injection molded material such as a polymeric material and may be integrally formed to include the footpad 36 with the anti-slip top surface. The injection molded part may further include different color parts including a color for the step pad to identify its location. The scuff plate 30 may be easily installed onto the vehicle underlying structure on the vehicle floor simply by attaching the clips 50 onto the tabs 54 and inserting them into the slots 52 with a locking engagement during assembly. It should be appreciated that the scuff plate 30 advantageously covers up portions of the floor and structures, including the seatbelt anchor 46, and provides a partial seat track side cover that abuts the seat track and covers at least a portion of the seat track.

The scuff plate 30 advantageously provides an integrated and connected step pad 36 to present a footpad top surface for foot placement to thereby enhance occupant access to the rear row of seating of a motor vehicle 10.

It is to be understood that variations and modifications can be made on the aforementioned structure without departing from the concepts of the present disclosure, and further it is to be understood that such concepts are intended to be covered by the following claims unless these claims by their language expressly state otherwise.

What is claimed is:

1. A vehicle comprising:
a first row of seating;
a second row of seating rearward of the first row of seating;
a side access door located in a door opening positioned proximate to the first row of seating, wherein the first row of seating has a first row seat that is moveable vehicle-forward to allow access to the second row of seating via the door opening; and
a scuff plate located proximate a lower edge of the door opening, the scuff plate comprising a front portion extending generally along a lower surface of the door opening and a rear portion extending rearward and inward proximate to a rear end of the first row seat and having a step pad providing a footpad top surface configured to support a foot of an occupant to access the second row of seating.

2. The vehicle of claim 1, wherein the first row seat has a seat track, wherein the rear portion of the scuff plate extends inward to at least partially abut the seat track.

3. The vehicle of claim 1, wherein the rear portion of the scuff plate extends at least partially over the seat track.

4. The vehicle of claim 3, wherein the rear portion of the scuff plate at least partially covers a seatbelt anchor.

5. The vehicle of claim 1, further comprising a plurality of connector clips for attaching the scuff plate to underlying structure supported on a floor of the vehicle.

6. The vehicle of claim 1, wherein the footpad top surface has an anti-slip pattern.

7. The vehicle of claim 1, wherein the first row seat has a seat base and a seat back, wherein the seat and seat back are configured to move longitudinally forward to provide access to the second row seating.

8. The vehicle of claim 7, wherein the seat back further tilts forward to provide access to the second row of seating.

9. The vehicle of claim 1, further comprising a third row of seating that serves as a front row of seating, and wherein the first row of seating serves as a middle row of seating and wherein the second row of seating serves as a rear row of seating.

10. The vehicle of claim 1, wherein the scuff plate comprises a polymeric material.

11. The vehicle of claim 10, wherein the footpad is integrally formed in the scuff plate.

12. A vehicle comprising:
a front row of seating;
a middle row of seating rearward of the front row of seating;
a rear row of seating rearward of the middle row of seating;
a side access door located in a door opening positioned proximate to the middle row of seating, wherein the middle row of seating has a middle row seat that is moveable vehicle-forward to allow access to the rear row of seating via the door opening; and
a scuff plate located proximate a lower edge of the door opening, the scuff plate comprising a front portion extending generally along an upper surface of the door opening and a rear portion extending rearward and inward proximate to a rear end of the middle row of seating and having a step pad providing a footpad top surface configured to support a foot of an occupant to access the rear row of seating.

13. The vehicle of claim 12, wherein the middle row seat has a seat track, wherein the rear portion of the scuff plate extends inward to at least partially abut the seat track.

14. The vehicle of claim 13, wherein the rear portion of the scuff plate extends at least partially over the seat track.

15. The vehicle of claim 14, wherein the second portion of the scuff plate at least partially covers a seatbelt anchor.

16. The vehicle of claim 12, further comprising a plurality connector clips for attaching the scuff plate to underlying structure supported on a floor of the vehicle.

17. The vehicle of claim 12, wherein the footpad top surface has an anti-slip pattern.

18. The vehicle of claim 12, wherein the middle row seat has a seat base and a seat back, wherein the seat base and seat back are configured to move longitudinally forward to provide access to the rear row seating.

19. The vehicle of claim 18, wherein the seat back further tilts forward to provide access to the rear row of seating.

20. The vehicle of claim 12, wherein the scuff plate comprises a polymeric material and the step pad is integrally formed in the scuff plate.
